(19) United States
(12) Patent Application Publication
(10) Pub. No.: US 2025/0307940 A1
(43) Pub. Date: Oct. 2, 2025

(54) SYSTEM AND METHOD FOR CREATING SERVICE PROVISIONS FOR RELATED SERVICE PRODUCTS

(71) Applicant: The Toronto-Dominion Bank, Toronto (CA)

(72) Inventors: Srinivasan CHELIAN, Kitchener (CA); Anurag ARORA, Winnipeg (CA); Surbhi DANDONA, Oakville (CA); Dipangshu CHATTERJEE, Winnipeg (CA); Andrew James TARRAS, Barrie (CA)

(21) Appl. No.: 18/620,200

(22) Filed: Mar. 28, 2024

(51) Int. Cl. G06Q 40/08

(52) U.S. Cl. CPC G06Q 40/08

(57) ABSTRACT

Computing platforms, methods, and storage media for creating service provisions for related service products are disclosed. Exemplary implementations may: obtain a service provision associated with a first service product; replace a grandfathering logic of the service product design tool with service provision availability parameters defined in a format independent of the service product design tool; and configure an availability script in the service product design tool based on the service provision availability parameters to enable implementation of the service provision in a second service product such that the service provision works differently with the first service product and the second service product.

### FIELD

The present disclosure relates to computing systems, including but not limited to computing platforms, methods, and storage media for creating service provisions for related service products.

### BACKGROUND

Computing systems may be used to provide any number of different service products. Each service product may include a number of different service provisions. For example a management system may provide a number of service provisions known as coverages. A coverage may be common to different products. In such cases, it can be desirable to provide the coverage in an efficient way in the different products.

Grandfathering is a function where a coverage may continue to be made available to a customer even though the coverage is discontinued or expired for new customers. Grandfathering has been used to provide a coverage from one product in another product. However, there are limitations on how the coverage can be made available, as well as a lack of flexibility in terms of modifying the coverage. Using grandfathering, such limitations would apply to other types of service provisions associated with respective service products.

Improvements in approaches for creating service provisions for related service products are desirable.

### BRIEF DESCRIPTION OF THE DRAWINGS

Embodiments of the present disclosure will now be described, by way of example only, with reference to the attached Figures.

FIG. 1 illustrates a system configured for creating service provisions for related service products, in accordance with one or more embodiments.

FIG. 2 illustrates another system configured for creating service provisions for related service products, in accordance with one or more embodiments.

FIG. 3 illustrates a method for creating service provisions for related service products, in accordance with one or more embodiments.

FIG. 4 illustrates a series of service product data transfers associated with a service product design tool in an in-sequence scenario.

FIG. 5 illustrates a series of service product data transfers associated with a service product design tool in an out-of-sequence scenario.

### DETAILED DESCRIPTION

Computing platforms, methods, and storage media for creating service provisions for related service products are disclosed. Exemplary implementations may: obtain a service provision associated with a first service product; replace a grandfathering logic of the service product design tool with service provision availability parameters defined in a format independent of the service product design tool; and configure an availability script in the service product design tool based on the service provision availability parameters to enable implementation of the service provision in a second service product such that the service provision works differently with the first service product and the second service product.

For example, the service product may comprise an insurance product and the service provision may comprise an insurance coverage. In an example embodiment, the present disclosure provides a platform for creating related insurance policy coverages with modifiable parameters that work differently for a product in different lines of business. According to an example embodiment of the present disclosure, a system provides a similar insurance coverage in two different products. Rather than duplicating and grandfathering a shared coverage with very limited modification options, the system provides the ability to work with one single coverage and have it work differently with a first product and a second product. This avoids the need to duplicate the coverage, and provides flexibility to modify parameters of the coverage in different insurance products, while still having the coverages linked.

One aspect of the present disclosure relates to a computing platform configured for creating service provisions for related service products. The computing platform may include a non-transient computer-readable storage medium having executable instructions embodied thereon. The computing platform may include one or more hardware processors configured to execute the instructions. The processor(s) may execute the instructions to obtain a service provision associated with a first service product. The first service product may be accessible in a service product design tool including grandfathering logic. The processor(s) may execute the instructions to replace the grandfathering logic of the service product design tool with service provision availability parameters defined in a format independent of the service product design tool. The processor(s) may execute the instructions to configure an availability script in the service product design tool based on the service provision availability parameters to enable implementation of the service provision in a second service product such that the service provision works differently with the first service product and the second service product.

Another aspect of the present disclosure relates to a method for creating service provisions for related service products. The method may include obtaining a service provision associated with a first service product. The first service product may be accessible in a service product design tool including grandfathering logic. The method may include replacing the grandfathering logic of the service product design tool with service provision availability parameters defined in a format independent of the service product design tool. The method may include configuring an availability script in the service product design tool based on the service provision availability parameters to enable implementation of the service provision in a second service product such that the service provision works differently with the first service product and the second service product.

Yet another aspect of the present disclosure relates to a non-transient computer-readable storage medium having instructions embodied thereon, the instructions being executable by one or more processors to perform a method for creating service provisions for related service products. The method may include obtaining a service provision associated with a first service product. The first service product may be accessible in a service product design tool including grandfathering logic. The method may include replacing the grandfathering logic of the service product design tool with service provision availability parameters defined in a format independent of the service product design tool. The method may include configuring an availability script in the service product design tool based on the service provision availability parameters to enable implementation of the service provision in a second service product such that the service provision works differently with the first service product and the second service product.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

A service product may refer to a software product providing a service, such as an insurance product or a project management product. A service product may include a number of different service provisions. For example, an insurance management system may provide a number of service provisions known as coverages related to an insurance product, such as an insurance policy. The same coverage may be common to different insurance products, for example a personal insurance policy and a business insurance policy. The insurance management system may be an insurance product design tool, such as Guidewire™, which is used by a majority of personal and commercial insurance carriers.

According to known approaches, a coverage is typically duplicated with same name, but the duplicated coverages are linked to the same underlying coverage. Duplicating may be easy in effort, but passing data to third party systems can be costly. Changing/duplicating can also cause undesirable effects for all supporting coverages. Embodiments of the present disclosure solve the technical problem of the undesirable effects introduced by changing or duplicating a coverage according to known approaches.

According to embodiments of the present disclosure, a system does not have to duplicate the coverage in a scenario where the same coverage is intended to work differently in two different policies. For example, embodiments of the present disclosure can work with one single service provision or coverage, and have it work differently with a first product and a second product.

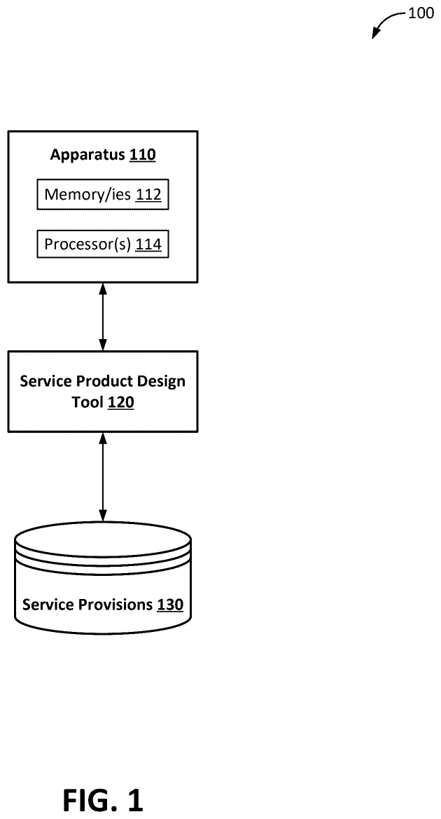

FIG. 1 illustrates a system 100 configured for creating service provisions for related service products, in accordance with one or more embodiments. The system 100 comprises an apparatus 110, which may be a may be a service provision management apparatus. The system 100 comprises a service product design tool 120, for example such as Guidewire™ for designing an insurance product. A service provision database 130 may be configured to store a plurality of service provisions, such as insurance coverages. The apparatus 110 may include one or more memories 112, which may comprise a non-transient computer-readable storage medium having executable instructions embodied thereon. The apparatus 110 may include one or more hardware processors 114 configured to execute the instructions. The apparatus 110 may be in communication with the service product design tool 120, and with the service provision database 130, either directly or via the service product design tool 120.

The processor(s) 114 may be configured to obtain a service provision associated with a first service product. The service provision may be obtained from the service provision database 130. A first service product may be accessible in the service product design tool 120, where the service product design tool 120 includes grandfathering logic. The processor(s) 114 may be configured to replace the grandfathering logic of the service product design tool 120 with service provision availability parameters defined in a format independent of the service product design tool 120. The processor(s) 114 may be configured to configure an availability script in the service product design tool 120 based on the service provision availability parameters to enable implementation of the service provision in a second service product such that the service provision works differently with the first service product and the second service product.

The apparatus 110 may cooperate with the service product design tool 120 and/or the service provision database 130 to improve functioning of a processor executing or associated with execution of the apparatus, by making the processor more efficient. For example, the apparatus 110 may enable implementation of a service provision in a second service product such that the service provision works differently with the first service product and the second service product, without the drawbacks and limitations of a grandfathering function and without duplicating the service provision, reducing the processor load and cost, as well as reducing the memory required. Such improvements and solutions to computer problems are also achieved by methods of one or more embodiments described and illustrated herein.

Consider a second service product, such as a commercial auto insurance product, which leverages aspects of a personal auto insurance product, a first service product, to reuse common features of Personal/Commercial Auto. For example, one of the coverages (Endorsement 27) is a common coverage used for both personal and commercial service products. This coverage may be grandfathered only in a personal product which means this coverage should be available for existing customers even though the coverage is discontinued or expired for new customers. It may be desirable for a commercial product to use the same coverage but without inheriting behaviour from the personal lines service product.

Guidewire's Product Designer supports grandfathering with an out of the box framework “Grandfather States”, but there is a limitation in Grandfather table in that it cannot be extended to add a line of business or product type. Such a known system can only continue to have the coverage available based on underwriting company, expiration date and state regardless of its effective date. There are potential workarounds provided by Guidewire, but all such known solutions have technical limitations. For example, using an effdated (effective dated) property “basedOn” cannot be used for out-of-sequence scenarios. The model date is set when the transaction is bound, and because product model synchronization and coverage availability checks trigger before binding, such an approach will not work.

Most other known approaches create a new coverage and utilize it for the other product. This is a very inefficient and an expensive solution as the new coverage will warrant wholesale changes across the applications including Guidewire Policy Center, Claim Center, Documents/Forms, and Downstream applications. This involves significant maintenance and delivery issues for any product that is already in Production.

Because of such challenges and technical problems with known approaches, embodiments of the present disclosure provide a new framework that is configured to bypass out-of-the-box grandfathering logic provided as part of a service product design tool, and implement something similar to the grandfathering logic outside of the service product design tool, for example in Guidewire Gosu classes. Gosu is a programming language that runs on a Java Virtual Machine.

When embodiments of the present disclosure providing an apparatus 110 are deployed, an implementation timeline may be in the ballpark of 5 days, as opposed to about 26 days using known approaches, thereby significantly reducing cost of implementation. Embodiments of the present disclosure, while solving a problem of providing the same service provision in two service products without duplicating the service provision, improve functioning of a processor executing or associated with the system. This reduces the processor load and cost, and reduces the memory required, compared to having to duplicate the service provision and/or implement grandfathering which has technical problems and inconsistency of service behaviour, particularly with out-of-sequence transactions.

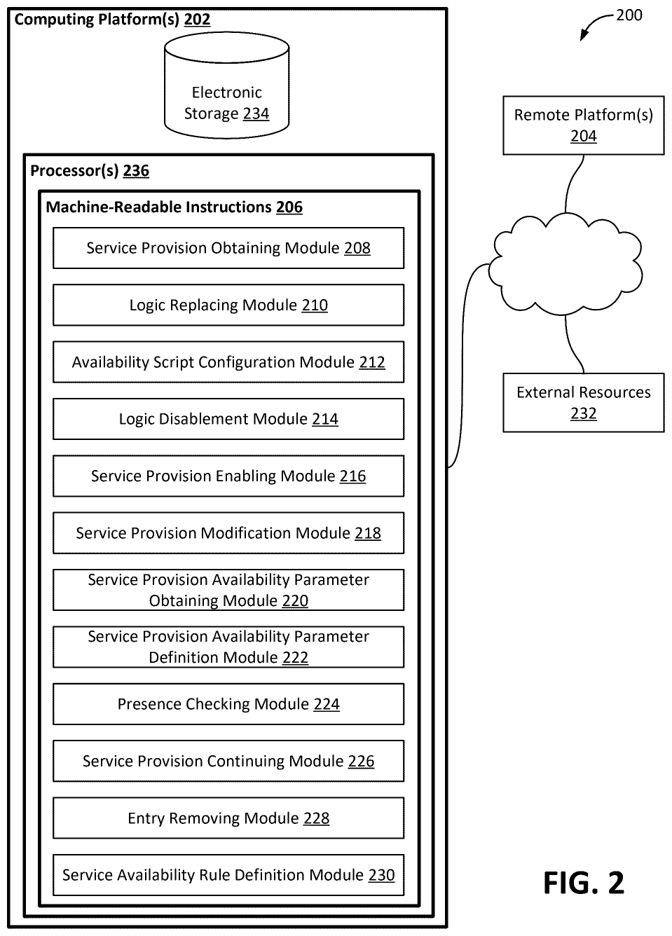

FIG. 2 illustrates a system 200 configured for creating service provisions for related service products, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of service provision obtaining module 208, logic replacing module 210, availability script configuration module 212, logic disablement module 214, service provision enabling module 216, service provision modification module 218, service provision availability parameter obtaining module 220, service provision availability parameter definition module 222, presence checking module 224, service provision continuing module 226, entry removing module 228, service availability rule definition module 230, and/or other instruction modules.

Service provision obtaining module 208 may be configured to obtain a service provision associated with a first service product. The service provision may include a coverage associated with the first service product. The service product design tool may be implemented as Guidewire and the service provision availability parameters may be defined with respect to the Gosu programming language. The first service product may be accessible in a service product design tool including grandfathering logic.

Logic replacing module 210 may be configured to replace the grandfathering logic of the service product design tool with service provision availability parameters defined in a format independent of the service product design tool. Replacing the grandfathering logic and configuring the availability script may enable accurate implementation of the service provision in relation to in-sequence and out-of-sequence transactions.

Availability script configuration module 212 may be configured to configure an availability script in the service product design tool based on the service provision availability parameters to enable implementation of the service provision in a second service product such that the service provision works differently with the first service product and the second service product.

Logic disablement module 214 may be configured to disable the grandfathering logic for the first service product.

Service provision enabling module 216 may be configured to enable implementation of the service provision in the second service product while the service provision in the first service product remains unduplicated. In some implementations, the first and second service products may include first and second insurance products.

Service provision modification module 218 may be configured to enable modification of the service provision in the first service product and modification of the service provision in the second service product while maintaining a link between the first and second service products.

Service provision availability parameter obtaining module 220 may be configured to obtain the service provision availability parameters.

Service provision availability parameter definition module 222 may be configured to define the service provision availability parameters in a software class defined in relation to service product design tool. The service product design tool may include an insurance product design tool.

Presence checking module 224 may be configured to, for all transactions that may be out-of-sequence, check for the presence the service provision in a most recent transaction.

Service provision continuing module 226 may be configured to, if the service provision exists in the most recent transaction, continue to have the service provision in a current transaction.

Entry removing module 228 may be configured to remove, from a grandfathering states table, all entries associated with the service provision.

Service availability rule definition module 230 may be configured to define a service availability rule for the first service product and for the second service product for all transactions that may be out-of-sequence. Service availability rule definition module 230 may be configured to check for the presence the service provision in a most recent transaction, and if the service provision exists in the most recent transaction then continue to have the service provision in a current transaction.

In some embodiments, computing platform(s) 202, remote platform(s) 204, and/or external resources 232 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 232 may be operatively linked via some other communication media.

A given remote platform 204 may include one or more processors configured to execute computer program modules. The computer program modules may be configured to enable an expert or user associated with the given remote platform 204 to interface with system 200 and/or external resources 232, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 232 may include sources of information outside of system 200, external entities participating with system 200, and/or other resources. In some embodiments, some or all of the functionality attributed herein to external resources 232 may be provided by resources included in system 200.

Computing platform(s) 202 may include electronic storage 234, one or more processors 236, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 234 may comprise non-transitory storage media that electronically stores information. The electronic storage media of electronic storage 234 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 234 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 234 may include one or more virtual storage resources (e.g., cloud storage, a virtual private network, and/or other virtual storage resources). Electronic storage 234 may store software algorithms, information determined by processor(s) 236, information received from computing platform(s) 202, information received from remote platform(s) 204, and/or other information that enables computing platform(s) 202 to function as described herein.

Processor(s) 236 may be configured to provide information processing capabilities in computing platform(s) 202. As such, processor(s) 236 may include one or more of a digital processor, an analog processor, a digital circuit designed to process information, an analog circuit designed to process information, a state machine, and/or other mechanisms for electronically processing information. Although processor(s) 236 is shown in FIG. 2 as a single entity, this is for illustrative purposes only. In some embodiments, processor(s) 236 may include a plurality of processing units. These processing units may be physically located within the same device, or processor(s) 236 may represent processing functionality of a plurality of devices operating in coordination. Processor(s) 236 may be configured to execute modules 208, 210, 212, 214, 216, 218, 220, 222, 224, 226, 228, and/or 230, and/or other modules. Processor(s) 236 may be configured to execute modules 208, 210, 212, 214, 216, 218, 220, 222, 224, 226, 228, and/or 230, and/or other modules by software; hardware; firmware; some combination of software, hardware, and/or firmware; and/or other mechanisms for configuring processing capabilities on processor(s) 236. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, and/or 230 are illustrated in FIG. 2 as being implemented within a single processing unit, in embodiments in which processor(s) 236 includes multiple processing units, one or more of modules 208, 210, 212, 214, 216, 218, 220, 222, 224, 226, 228, and/or 230 may be implemented remotely from the other modules. The description of the functionality provided by the different modules 208, 210, 212, 214, 216, 218, 220, 222, 224, 226, 228, and/or 230 described below is for illustrative purposes, and is not intended to be limiting, as any of modules 208, 210, 212, 214, 216, 218, 220, 222, 224, 226, 228, and/or 230 may provide more or less functionality than is described. For example, one or more of modules 208, 210, 212, 214, 216, 218, 220, 222, 224, 226, 228, and/or 230 may be eliminated, and some or all of its functionality may be provided by other ones of modules 208, 210, 212, 214, 216, 218, 220, 222, 224, 226, 228, and/or 230. As another example, processor(s) 236 may be configured to execute one or more additional modules that may perform some or all of the functionality attributed below to one of modules 208, 210, 212, 214, 216, 218, 220, 222, 224, 226, 228, and/or 230.

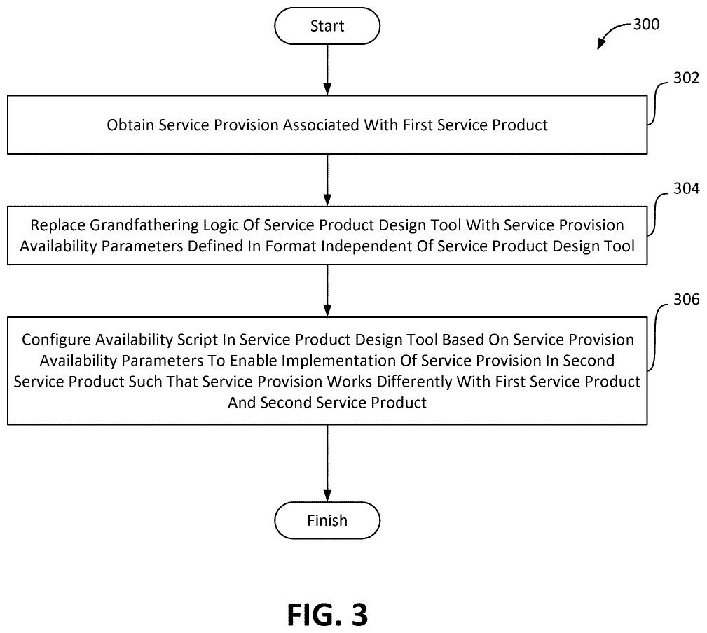

FIG. 3 illustrates a method 300 for creating service provisions for related service products, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining a service provision associated with a first service product. The first service product may be accessible in a service product design tool including grandfathering logic. Operation 302 may be performed by one or more hardware processors configured by machine-readable instructions including a module that is the same as or similar to service provision obtaining module 208, in accordance with one or more embodiments.

An operation 304 may include replacing the grandfathering logic of the service product design tool with service provision availability parameters defined in a format independent of the service product design tool. Operation 304 may be performed by one or more hardware processors configured by machine-readable instructions including a module that is the same as or similar to logic replacing module 210, in accordance with one or more embodiments.

An operation 306 may include configuring an availability script in the service product design tool based on the service provision availability parameters to enable implementation of the service provision in a second service product such that the service provision works differently with the first service product and the second service product. Operation 306 may be performed by one or more hardware processors configured by machine-readable instructions including a module that is the same as or similar to availability script configuration module 212, in accordance with one or more embodiments.

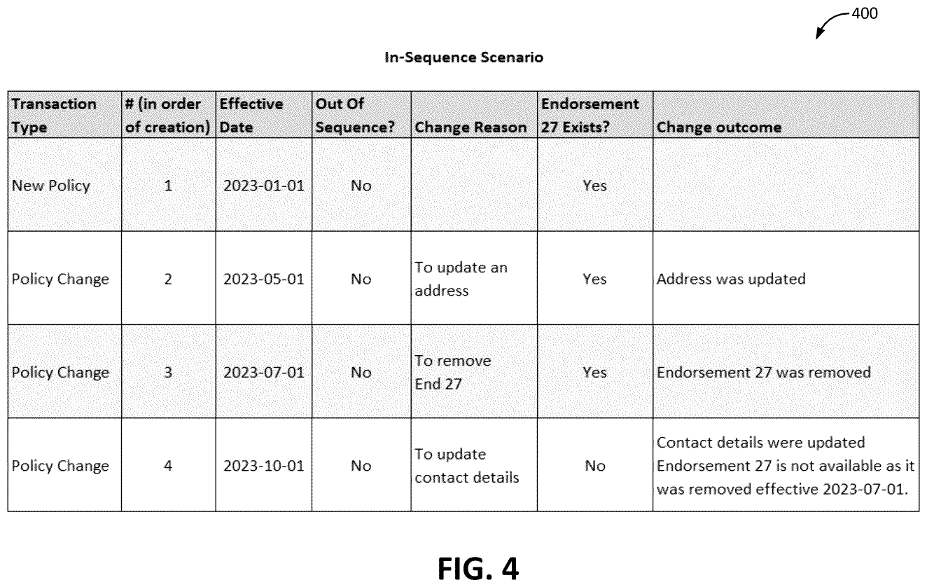

FIG. 4 illustrates a series 400 of service product data transfers associated with a service product design tool in an in-sequence scenario. An in-sequence scenario refers to a scenario in which the order of creation of the data transfers is in-sequence with respect to their effective dates, such that each data transfer has an effective date that is not before the effective date of the previous data transfer. While the example of FIG. 4 is applicable to any number of service products and related data transfers, an example is described in relation to an insurance policy having a plurality of transactions and a particular coverage, named Endorsement 27 (limit of liability for damage), that is desirable to include in different insurance policies, without the limitations of grandfathering.

In FIG. 4, transaction 1 comprises creation of a new insurance policy in which Endorsement 27 exists, having an effective date of 2023 Jan. 1. Since transaction 1 comprises creation of the policy, there is no change reason or change outcome. Transaction 2 comprises a policy change to update an address, with an effective date of 2023 May 1. The outcome of transaction 2 is that the address was updated, and Endorsement 27 still exists in the policy when transaction 2 occurred, as well as at the effective date of transaction 2.

Transaction 3 in FIG. 4 comprises a policy change to remove Endorsement 27 from the policy, with an effective date of 2023 Jul. 1. The result of the change is that Endorsement 27 was removed as of the effective date of 2023 Jul. 1, but Endorsement 27 existed in the policy at the time of execution transaction 3. Finally, in transaction 4, a further policy change to update contact details is effective 2023 Oct. 1, with the change outcome being that the contact details were updated. Since the transactions are all in-sequence, and none of them is out-of-sequence, Endorsement 27 is not available in the policy at the effective date of 2023 Oct. 1 of transaction 4, as well as at the date on which transaction 3 was executed, since it was removed effective 2023 Jul. 1 as part of transaction 3.

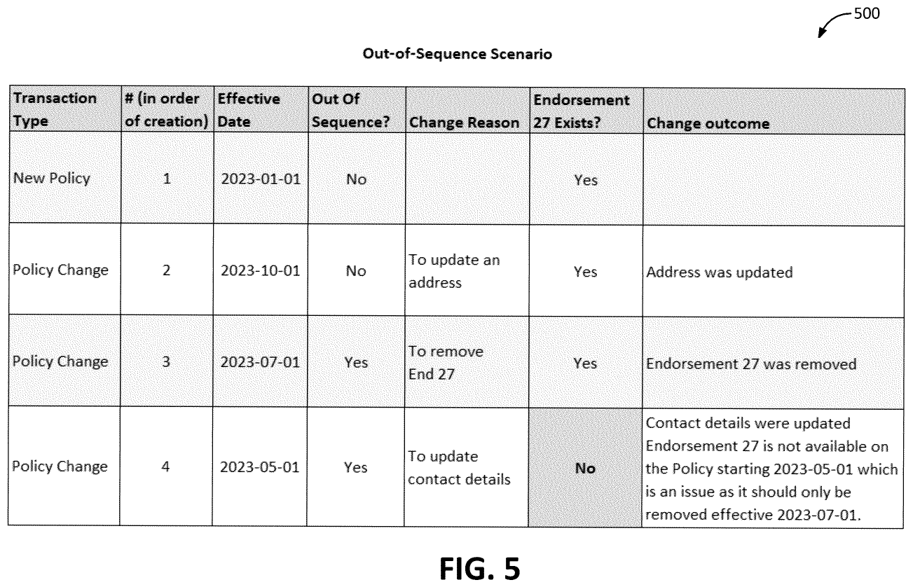

FIG. 5 illustrates a series 500 of service product data transfers associated with a service product design tool in an out-of-sequence scenario. An out-of-sequence scenario refers to a scenario in which the order of creation of at least one of the data transfers is out-of-sequence with respect to their effective dates, such that at least one data transfer has an effective date that is before the effective date of a previous data transfer. While the example of FIG. 5 is applicable to any number of service products and related data transfers, an example is described in relation to an insurance policy having a plurality of transactions and a particular coverage, named Endorsement 27, that is desirable to include in different insurance policies, without the limitations of grandfathering.

In FIG. 5, transaction 1 comprises creation of a new insurance policy in which Endorsement 27 exists, having an effective date of 2023 Jan. 1. Since transaction 1 comprises creation of the policy, there is no change reason or change outcome. Transaction 2 comprises a policy change to update an address, with an effective date of 2023 Oct. 1. The outcome of transaction 2 is that the address was updated, and Endorsement 27 still exists in the policy at the effective date of transaction 2, and at the time of execution of transaction 2.

Transaction 3 in FIG. 5 comprises a policy change to remove Endorsement 27 from the policy, with an effective date of 2023 Jul. 1. At the time of execution of transaction 3, Endorsement 27 still exists in the policy. The result of the change is that Endorsement 27 was removed as of the effective date of 2023 Jul. 1. However, this is out-of-sequence with respect to transaction 2, which has an effective date of 2023 Oct. 1.

Finally, in transaction 4 in FIG. 5, a further policy change to update contact details is effective 2023 May 1, with the change outcome being that the contact details were updated as of the effective date. However, transaction 4 is out-of-sequence with respect to the effective dates of both transaction 2 and transaction 3 in FIG. 5. Therefore, in terms of the order of creation of the transactions, Endorsement 27 does not exist at the time of execution of transaction 4, since Endorsement 27 is not available on the policy starting 2023 May 1. However, Endorsement 27 should only have been removed effective 2023 Jul. 1, meaning that Endorsement 27 should have existed and been available at the time of transaction 4 with respect to effective dates.

Embodiments of the present disclosure provide a framework configured to bypass out of the box grandfathering logic in a service product design tool, for example in Guidewire Product Designer, and implement the Grandfathering logic outside of the service product design tool, for example in Guidewire Gosu classes. Embodiments of the present disclosure may remove all entries for this coverage from a Grandfathering States table. Embodiments of the present disclosure may define a coverage availability rule in a Gosu class for both Products, which may comprise the following steps: check for the presence of coverage in the most recent transaction; if the coverage exists in that transaction, continue to have the coverage in the current transaction. This check may be done for all transactions, optionally except New Business, that can be out-of-sequence. Embodiments of the present disclosure may configure an availability script in Product Designer for the new Availability rule created above.

Embodiments of the present disclosure may implement these steps as part of, or in relation to, a service product design tool such as the Guidewire application. The system may selectively utilize some of the Guidewire functionality, and bypass certain logic. In an example embodiment, a system may comprise an accelerator or an SDK configured to develop an initiation kit. In such a case the base product of Guidewire may still be the same, and may be packaged into an accelerator, which for example may contextualize which endorsement, which line of business, details of current implementation.

According to one or more embodiments, a technical solution provides flexibility for future implementations where coverages are coexisting in two Products under the same Line of Business with different availability conditions. According to one or more embodiments, service provision logic is easily extendable and modifiable as per business requirements, since grandfathering logic now resides outside of the service product design tool, for example in Guidewire gosu classes. According to one or more embodiments, the solutions are purely technical and do not have any impact on user experience and production behavior. According to one or more embodiments, the solution has avoided separating out a coverage for commercial and personal service products which could have led to large downstream application impact and was very time consuming. According to one or more embodiments, redundancy is reduced, achieving the outcome with shorter timeline, reduced costs and reduced redundant code. According to one or more embodiments, the technical solution takes out the limitation of underwriting company, effective date, associated with known approaches. While embodiments of the present disclosure may use grandfather logic, embodiments of the present disclosure provide the ability to more fully modify properties associated with the grandfathered table/policy, in contrast to the out-of-the-box Guidewire functionality which is limited to 3 properties.

The examples shown in FIG. 4 and FIG. 5, and particularly the out-of-sequence example of FIG. 5, show a technical problem with known approaches. FIG. 5 illustrates an example of a technical problem where grandfathering introduces erroneous behaviour with out-of-sequence transactions, where the effective date of a change may be out of sequence in terms of the order of the transactions.

Embodiments of the present disclosure provide a technical solution including providing computing platforms, methods, and storage media for creating service provisions for related service products. The technical solution provided by embodiments of the present disclosure solves at least one technical problem associated with known approaches. For example, grandfathering functionality may behave properly for in-sequence transactions, but introduces technical problems with respect to out-of-sequence transactions. According to one or more embodiments, the present disclosure solves this technical problem by providing a technical solution including defining service provision availability parameters and configuring an availability script in a service product design tool based on the service provision availability parameters. This enables implementation of the service provision in a second service product such that the service provision works differently with the first service product and the second service product, for example without duplicating the service provision. The approach of embodiments of the present disclosure ensures consistent behaviour with both in-sequence transactions and out-of-sequence transactions, providing a technical solution to the technical problem of known approaches which result in incorrect behaviour for out-of-sequence transactions.

In an example implementation, the service product may comprise an insurance product and the service provision may comprise an insurance coverage. In an example embodiment, the present disclosure provides a platform for creating related insurance policy coverages with modifiable parameters that work differently for a product in different lines of business, and yet ensures consistent behaviour for both in-sequence transactions and out-of-sequence transactions. According to an example embodiment of the present disclosure, a system may be configured to provide a similar insurance coverage in two different products. Rather than duplicating and grandfathering a shared coverage with very limited modification options, the system provides the ability to work with one single coverage and have it work differently with a first product and a second product. This avoids the need to duplicate the coverage, and provides flexibility to modify parameters of the coverage in different insurance products, while still having the coverages linked.

A further example is provided to illustrate technical improvements provided by embodiments of the present disclosure. In order to implement a solution of creating a second service product that inherits a service provision of a first service product, the following steps may be implemented according to an example embodiment:
1. In Product designer, disable all the logic under Grandfather States table by entering the End effective date as Jan. 1, 2000.
2. Define Coverage Availability rule in a Gosu class for both Products
3. Configure an availability script in Product Designer for the new Availability rule created in Step #2

These 3 steps according to one or more embodiments may take an estimated 5 person days, with about 2 person days for the Guidewire Policy Center work, and the remaining work for additional activities. There is no work needed for external applications, since this solution does not have any downstream applications impact; it is purely a Guidewire Policy center change, and no backward compatibility script is required.

In contrast, according to a known approach, the following steps would need to be implemented:
1. Internal (Guidewire Policy Center) steps
a) Create a new coverage in Guidewire Product designer with a unique coverage code and configure coverage terms, Offerings and coverage availability conditions i.e., effective date and province.
b) Implement scripts (Initialization, Removal, availability, and existence) for new coverage in gosu
c) Add dependee rule for this coverage as this coverage is dependent on other primary coverage
d) Modify removal scripts of primary coverages like (All Perils, Collison, Comprehensive and Liability Bodily Injury) to remove this new coverage if primary coverages are removed.
e) Application UI changes to show this new coverage on the screen
f) Create Form pattern (BAAPON027) for Endorsement 27 form with new coverage code
g) Map policy forms in policy document package and send to document generation team
2. External (Downstream applications) steps
a) Digital Quoter
   i) Changes on the User interface to show the new coverage on the screen and map the new coverage code with it
b) Rating
   i) Premium calculation associated with the new coverage based on the limits/deductibles provided by user
   ii) Regression suite run for premium matching/verification
c) Document Generation-handle dynamic data changes
   i) Transform the data received from Policy Center into actual values to be printed in the letters (which will be sent to customers)
   ii) Process the data and send to Vendor for printing the documents
d) CMS-handle static data changes
   i) New Coverage code to Coverage name mapping
e) Daas
   i) New Coverage code to Coverage name mapping
f) Backward compatibility script
   i) Identify all the Commercial Auto policies currently in production which has Endorsement 27 added
   ii) Retire the old coverage code and replace it with new coverage code
g) Run a complete regression suite to make sure Personal lines is not impacted

The 17 steps outlined above for a known solution may take an estimated 26 person days, in contrast to the much improved total of 5 person days for an embodiment of the present disclosure. The known approach includes about 5 person days for Guidewire Policy Center work (compared to 2 for embodiments of the present disclosure), about 12 person days for external applications (compared to none for embodiments of the present disclosure), and about 7 person days for additional activities (compared to 3 for embodiments of the present disclosure).

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for creating service provisions for related service products. The system may include one or more hardware processors configured by machine-readable instructions. The processor(s) may be configured to obtain a service provision associated with a first service product. The first service product may be accessible in a service product design tool including grandfathering logic. The processor(s) may be configured to replace the grandfathering logic of the service product design tool with service provision availability parameters defined in a format independent of the service product design tool. The processor(s) may be configured to configure an availability script in the service product design tool based on the service provision availability parameters to enable implementation of the service provision in a second service product such that the service provision works differently with the first service product and the second service product.

In some implementations of the system, the processor(s) may be configured to disable the grandfathering logic for the first service product.

In some implementations of the system, the processor(s) may be configured to enable implementation of the service provision in the second service product while the service provision in the first service product remains unduplicated.

In some implementations of the system, the processor(s) may be configured to enable modification of the service provision in the first service product and modification of the service provision in the second service product while maintaining a link between the first and second service products.

In some implementations of the system, the processor(s) may be configured to obtain the service provision availability parameters.

In some implementations of the system, the processor(s) may be configured to define the service provision availability parameters in a software class defined in relation to service product design tool.

In some implementations of the system, the processor(s) may be configured to, for all transactions that may be out of sequence, check for the presence the service provision in a most recent transaction. In some implementations of the system, the processor(s) may be configured to, if the service provision exists in the most recent transaction, continue to have the service provision in a current transaction.

In some implementations of the system, the processor(s) may be configured to remove, from a grandfathering states table, all entries associated with the service provision. In some implementations of the system, the processor(s) may be configured to define a service availability rule for the first service product and for the second service product for all transactions that may be out of sequence by checking for the presence the service provision in a most recent transaction and if the service provision exists in the most recent transaction then continuing to have the service provision in a current transaction.

In some implementations of the system, the first and second service products may include first and second insurance products. In some implementations of the system, the service product design tool may include an insurance product design tool. In some implementations of the system, the service provision may include a coverage associated with the first insurance product.

In some implementations of the system, the insurance product design tool may include Guidewire and the service provision availability parameters are defined with respect to the Gosu programming language.

In some implementations of the system, the replacing the grandfathering logic and configuring the availability script may enable accurate implementation of the service provision in relation to in-sequence and out-of-sequence transactions.

Another aspect of the present disclosure relates to a method for creating service provisions for related service products. The method may include obtaining a service provision associated with a first service product. The first service product may be accessible in a service product design tool including grandfathering logic. The method may include replacing the grandfathering logic of the service product design tool with service provision availability parameters defined in a format independent of the service product design tool. The method may include configuring an availability script in the service product design tool based on the service provision availability parameters to enable implementation of the service provision in a second service product such that the service provision works differently with the first service product and the second service product.

In some implementations of the method, it may include disabling the grandfathering logic for the first service product.

In some implementations of the method, it may include enabling implementation of the service provision in the second service product while the service provision in the first service product remains unduplicated.

In some implementations of the method, it may include enabling modification of the service provision in the first service product and modification of the service provision in the second service product while maintaining a link between the first and second service products.

In some implementations of the method, it may include obtaining the service provision availability parameters.

In some implementations of the method, it may include defining the service provision availability parameters in a software class defined in relation to service product design tool.

In some implementations of the method, it may include, for all transactions that may be out of sequence, checking for the presence the service provision in a most recent transaction. In some implementations of the method, it may include, if the service provision exists in the most recent transaction, continuing to have the service provision in a current transaction.

In some implementations of the method, it may include removing, from a grandfathering states table, all entries associated with the service provision. In some implementations of the method, it may include defining a service availability rule for the first service product and for the second service product for all transactions that may be out of sequence by checking for the presence the service provision in a most recent transaction and if the service provision exists in the most recent transaction then continuing to have the service provision in a current transaction.

In some implementations of the method, the first and second service products may include first and second insurance products. In some implementations of the method, the service product design tool may include an insurance product design tool. In some implementations of the method, the service provision may include a coverage associated with the first insurance product.

In some implementations of the method, the insurance product design tool may include Guidewire and the service provision availability parameters are defined with respect to the Gosu programming language.

In some implementations of the method, the replacing the grandfathering logic and configuring the availability script may enable accurate implementation of the service provision in relation to in-sequence and out-of-sequence transactions.

Yet another aspect of the present disclosure relates to a non-transient computer-readable storage medium having instructions embodied thereon, the instructions being executable by one or more processors to perform a method for creating service provisions for related service products. The method may include obtaining a service provision associated with a first service product. The first service product may be accessible in a service product design tool including grandfathering logic. The method may include replacing the grandfathering logic of the service product design tool with service provision availability parameters defined in a format independent of the service product design tool. The method may include configuring an availability script in the service product design tool based on the service provision availability parameters to enable implementation of the service provision in a second service product such that the service provision works differently with the first service product and the second service product.

In some implementations of the computer-readable storage medium, the method may include disabling the grandfathering logic for the first service product.

In some implementations of the computer-readable storage medium, the method may include enabling implementation of the service provision in the second service product while the service provision in the first service product remains unduplicated.

In some implementations of the computer-readable storage medium, the method may include enabling modification of the service provision in the first service product and modification of the service provision in the second service product while maintaining a link between the first and second service products.

In some implementations of the computer-readable storage medium, the method may include obtaining the service provision availability parameters.

In some implementations of the computer-readable storage medium, the method may include defining the service provision availability parameters in a software class defined in relation to service product design tool.

In some implementations of the computer-readable storage medium, the method may include, for all transactions that may be out of sequence, checking for the presence the service provision in a most recent transaction. In some implementations of the computer-readable storage medium, the method may include, if the service provision exists in the most recent transaction, continuing to have the service provision in a current transaction.

In some implementations of the computer-readable storage medium, the method may include removing, from a grandfathering states table, all entries associated with the service provision. In some implementations of the computer-readable storage medium, the method may include defining a service availability rule for the first service product and for the second service product for all transactions that may be out of sequence by checking for the presence the service provision in a most recent transaction and if the service provision exists in the most recent transaction then continuing to have the service provision in a current transaction.

In some implementations of the computer-readable storage medium, the first and second service products may include first and second insurance products. In some implementations of the computer-readable storage medium, the service product design tool may include an insurance product design tool. In some implementations of the computer-readable storage medium, the service provision may include a coverage associated with the first insurance product.

In some implementations of the computer-readable storage medium, the insurance product design tool may include Guidewire and the service provision availability parameters are defined with respect to the Gosu programming language.

In some implementations of the computer-readable storage medium, the replacing the grandfathering logic and configuring the availability script may enable accurate implementation of the service provision in relation to in-sequence and out-of-sequence transactions.

Still another aspect of the present disclosure relates to a system configured for creating service provisions for related service products. The system may include means for obtaining a service provision associated with a first service product. The first service product may be accessible in a service product design tool including grandfathering logic. The system may include means for replacing the grandfathering logic of the service product design tool with service provision availability parameters defined in a format independent of the service product design tool. The system may include means for configuring an availability script in the service product design tool based on the service provision availability parameters to enable implementation of the service provision in a second service product such that the service provision works differently with the first service product and the second service product.

In some implementations of the system, the system may include means for disabling the grandfathering logic for the first service product.

In some implementations of the system, the system may include means for enabling implementation of the service provision in the second service product while the service provision in the first service product remains unduplicated.

In some implementations of the system, the system may include means for enabling modification of the service provision in the first service product and modification of the service provision in the second service product while maintaining a link between the first and second service products.

In some implementations of the system, the system may include means for obtaining the service provision availability parameters.

In some implementations of the system, the system may include means for defining the service provision availability parameters in a software class defined in relation to service product design tool.

In some implementations of the system, the system may include means for, for all transactions that may be out of sequence, checking for the presence the service provision in a most recent transaction. In some implementations of the system, the system may include means for, if the service provision exists in the most recent transaction, continuing to have the service provision in a current transaction.

In some implementations of the system, the system may include means for removing, from a grandfathering states table, all entries associated with the service provision. In some implementations of the system, the system may include means for defining a service availability rule for the first service product and for the second service product for all transactions that may be out of sequence by checking for the presence the service provision in a most recent transaction and if the service provision exists in the most recent transaction then continuing to have the service provision in a current transaction.

In some implementations of the system, the first and second service products may include first and second insurance products. In some implementations of the system, the service product design tool may include an insurance product design tool. In some implementations of the system, the service provision may include a coverage associated with the first insurance product.

In some implementations of the system, the insurance product design tool may include Guidewire and the service provision availability parameters are defined with respect to the Gosu programming language.

In some implementations of the system, the replacing the grandfathering logic and configuring the availability script may enable accurate implementation of the service provision in relation to in-sequence and out-of-sequence transactions.

A further aspect of the present disclosure relates to a computing platform configured for creating coverages for related insurance products. The computing platform may include a non-transient computer-readable storage medium having executable instructions embodied thereon. The computing platform may include one or more hardware processors configured to execute the instructions. The processor(s) may execute the instructions to obtain an insurance coverage associated with a first insurance product. The first insurance product may be accessible in an insurance product design tool including grandfathering logic. The processor(s) may execute the instructions to replace the grandfathering logic of the insurance product design tool with coverage availability parameters defined in a format independent of the insurance product design tool. The processor(s) may execute the instructions to configure an availability script in the insurance product design tool based on the coverage availability parameters to enable implementation of the insurance coverage in a second insurance product such that the insurance coverage works differently with the first insurance product and the second insurance product.

Even another aspect of the present disclosure relates to a computing platform configured for creating service provisions for related service products. The computing platform may include a non-transient computer-readable storage medium having executable instructions embodied thereon. The computing platform may include one or more hardware processors configured to execute the instructions. The processor(s) may execute the instructions to obtain a service provision associated with a first service product. The first service product may be accessible in a service product design tool including grandfathering logic. The processor(s) may execute the instructions to replace the grandfathering logic of the service product design tool with service provision availability parameters defined in a format independent of the service product design tool. The processor(s) may execute the instructions to configure an availability script in the service product design tool based on the service provision availability parameters to enable implementation of the service provision in a second service product such that the service provision works differently with the first service product and the second service product.

In some implementations of the computing platform, the processor(s) may execute the instructions to disable the grandfathering logic for the first service product.

In some implementations of the computing platform, the processor(s) may execute the instructions to enable implementation of the service provision in the second service product while the service provision in the first service product remains unduplicated.

In some implementations of the computing platform, the processor(s) may execute the instructions to enable modification of the service provision in the first service product and modification of the service provision in the second service product while maintaining a link between the first and second service products.

In some implementations of the computing platform, the processor(s) may execute the instructions to obtain the service provision availability parameters.

In some implementations of the computing platform, the processor(s) may execute the instructions to define the service provision availability parameters in a software class defined in relation to service product design tool.

In some implementations of the computing platform, the processor(s) may execute the instructions to, for all transactions that may be out of sequence, check for the presence the service provision in a most recent transaction. In some implementations of the computing platform, the processor(s) may execute the instructions to, if the service provision exists in the most recent transaction, continue to have the service provision in a current transaction.

In some implementations of the computing platform, the processor(s) may execute the instructions to remove, from a grandfathering states table, all entries associated with the service provision. In some implementations of the computing platform, the processor(s) may execute the instructions to define a service availability rule for the first service product and for the second service product for all transactions that may be out of sequence by checking for the presence the service provision in a most recent transaction and if the service provision exists in the most recent transaction then continuing to have the service provision in a current transaction.

In some implementations of the computing platform, the first and second service products may include first and second insurance products. In some implementations of the computing platform, the service product design tool may include an insurance product design tool. In some implementations of the computing platform, the service provision may include a coverage associated with the first insurance product.

In some implementations of the computing platform, the insurance product design tool may include Guidewire and the service provision availability parameters are defined with respect to the Gosu programming language.

In some implementations of the computing platform, the replacing the grandfathering logic and configuring the availability script may enable accurate implementation of the service provision in relation to in-sequence and out-of-sequence transactions.

What is claimed is:

1. An apparatus configured for creating service provisions for related service products, the apparatus comprising:
a non-transient computer-readable storage medium having executable instructions embodied thereon; and
one or more hardware processors configured to execute the instructions to:
obtain a service provision associated with a first service product, the first service product being accessible in a service product design tool including grandfathering logic;
replace the grandfathering logic of the service product design tool with service provision availability parameters defined in a format independent of the service product design tool; and
configure an availability script in the service product design tool based on the service provision availability parameters to enable implementation of the service provision in a second service product such that the service provision works differently with the first service product and the second service product.

2. The apparatus of claim 1 wherein the one or more hardware processors are further configured to execute the instructions to:
disable the grandfathering logic for the first service product.

3. The apparatus of claim 1 wherein the one or more hardware processors are further configured to execute the instructions to:
enable implementation of the service provision in the second service product while the service provision in the first service product remains unduplicated.

4. The apparatus of claim 1 wherein the one or more hardware processors are further configured to execute the instructions to:
enable modification of the service provision in the first service product and modification of the service provision in the second service product while maintaining a link between the first and second service products.

5. The apparatus of claim 1 wherein the one or more hardware processors are further configured to execute the instructions to:
obtain the service provision availability parameters.

6. The apparatus of claim 1 wherein the one or more hardware processors are further configured to execute the instructions to:
define the service provision availability parameters in a software class defined in relation to service product design tool.

7. The apparatus of claim 1 wherein the one or more hardware processors are further configured to execute the instructions to:
for all transactions that may be out of sequence:
check for the presence the service provision in a most recent transaction;
if the service provision exists in the most recent transaction, continue to have the service provision in a current transaction.

8. The apparatus of claim 1 wherein the one or more hardware processors are further configured to execute the instructions to:
remove, from a grandfathering states table, all entries associated with the service provision;
define a service availability rule for the first service product and for the second service product by, for all transactions that may be out of sequence:
checking for the presence the service provision in a most recent transaction;
if the service provision exists in the most recent transaction, continuing to have the service provision in a current transaction.

9. The apparatus of claim 1 wherein the first and second service products comprise first and second insurance products, the service product design tool comprises an insurance product design tool, and the service provision comprises a coverage associated with the first insurance product.

10. A processor-implemented method of creating service provisions for related service products, the method comprising:
obtaining a service provision associated with a first service product, the first service product being accessible in a service product design tool including grandfathering logic;
replacing the grandfathering logic of the service product design tool with service provision availability parameters defined in a format independent of the service product design tool; and
configuring an availability script in the service product design tool based on the service provision availability parameters to enable implementation of the service provision in a second service product such that the service provision works differently with the first service product and the second service product.

11. The method of claim 10 further comprising:
disabling the grandfathering logic for the first service product.

12. The method of claim 10 further comprising:
enabling implementation of the service provision in the second service product while the service provision in the first service product remains unduplicated.

13. The method of claim 10 further comprising:
enabling modification of the service provision in the first service product and modification of the service provision in the second service product while maintaining a link between the first and second service products.

14. The method of claim 10 further comprising:
obtaining the service provision availability parameters.

15. The method of claim 10 further comprising:
defining the service provision availability parameters in a software class defined in relation to service product design tool.

16. The method of claim 10 further comprising:
for all transactions that may be out of sequence:
checking for the presence the service provision in a most recent transaction;
if the service provision exists in the most recent transaction, continuing to have the service provision in a current transaction.

17. The method of claim 10 further comprising:
removing, from a grandfathering states table, all entries associated with the service provision;
defining a service availability rule for the first service product and for the second service product by, for all transactions that may be out of sequence:
checking for the presence the service provision in a most recent transaction;
if the service provision exists in the most recent transaction, continuing to have the service provision in a current transaction.

18. The method of claim 10 wherein the first and second service products comprise first and second insurance products, the service product design tool comprises an insurance product design tool, and the service provision comprises a coverage associated with the first insurance product.

19. A non-transient computer-readable storage medium having instructions embodied thereon, the instructions being executable by one or more processors to perform a method of creating service provisions for related service products, the method comprising:
obtaining a service provision associated with a first service product, the first service product being accessible in a service product design tool including grandfathering logic;
replacing the grandfathering logic of the service product design tool with service provision availability parameters defined in a format independent of the service product design tool; and
configuring an availability script in the service product design tool based on the service provision availability parameters to enable implementation of the service provision in a second service product such that the service provision works differently with the first service product and the second service product.

20. The non-transient computer-readable storage medium of claim 19 wherein the method further comprises:
enabling implementation of the service provision in the second service product while the service provision in the first service product remains unduplicated.
